(19) United States
(12) Patent Application Publication
(10) Pub. No.: US 2013/0319965 A1
(43) Pub. Date: Dec. 5, 2013

(54) PACIFIERS AND BOTTLE NIPPLES

(71) Applicant: April Reynolds, Old Bridge, NJ (US)

(72) Inventor: April Reynolds, Old Bridge, NJ (US)

(21) Appl. No.: 13/909,741

(22) Filed: Jun. 4, 2013

Related U.S. Application Data
(60) Provisional application No. 61/655,136, filed on Jun. 4, 2012.

(51) Int. Cl. A61J 11/00

(52) U.S. Cl. CPC A61J 11/0035
USPC 215/11.1

(57) ABSTRACT

A flavored infant device, in particular a flavored pacifier or nipple, which provides a long lasting, soothing alternative to traditional pacifiers and bottle nipples. The flavor infused pacifier or nipple provides a multiple use flavor delivery to an infant, without a substantial reduction in flavor.

### CLAIM OF PRIORITY

This application claims priority to U.S. Provisional Patent Application Ser. No. 61/655,136 filed Jun. 4, 2012 entitled “Improved Pacifiers and Bottle Nipples”, and is herein incorporated by reference in its entirety.

### FIELD OF THE INVENTION

The invention relates generally to improved pacifiers and bottle nipples.

### BACKGROUND

Currently there are a number of solutions for flavored pacifiers. Some of these solutions attempt to sooth babies, but these solutions fail to meet the needs of the market because they are only coated with flavoring and the flavor dissolves quickly. Other solutions attempt to retain flavor, but these solutions are similarly unable to meet the needs of the market because the flavor in the pacifier or bottle nipple does not last long enough. Still other solutions seek to be reusable, but these solutions also fail to meet market needs because they do not have an enjoyable taste for very long. Other pacifiers, such as the one described in U.S. Pat. No. 5,013,321 disclose a gel-dispensing pacifier that can be refilled with a flavored gel component. Although this configuration provides for a refillable option, the need for handling a separate gel container to refill the pacifier is equally as cumbersome and inconvenient.

It would be an advantage to have a device that addresses the need for flavor infused palatable baby pacifiers, which can be used to sooth a baby for longer. Furthermore, it would also be an advantage to have a device that lasted longer than only one use. Therefore, there currently exists a need in the market for a device that is flavorful for longer periods of time and more enjoyable and soothing than a traditional pacifier or bottle nipple.

### SUMMARY

The invention advantageously fills the aforementioned deficiencies by providing flavored pacifiers and bottle nipples, which provide a long lasting, soothing alternative to traditional pacifiers and bottle nipples.

In one example embodiment, an infant device is provided for administering a flavor comprising: a nipple element configured to have at least one layer infused with a flavor, a backing portion adapted to be attached to at least a portion of said nipple element, and a grasping member being integrally related to at least a portion of said backing portion. In a related example embodiment, the nipple element comprises at least two layers and wherein an outer layer of said nipple is infused with flavor and an inner layer is substantially free of infused flavor. The backing portion further comprises a threaded portion, wherein said threaded portion provides securement of said grasping member to said backing portion

In another example embodiment, a method is provided of administering a flavor to an infant comprising the steps of providing a favored infant device to an infant in need thereof, wherein said flavored infant device comprises a grasping member, a nipple element and a backing portion. In related embodiment, a method further comprising the step of providing a threaded portion to said backing portion thereby facilitating exposure of an inner part of the nipple element when the threaded portion is used.

In yet another example embodiment, an infant device for administering a flavor comprising a nipple element configured to have at least one layer infused with a flavor; a backing portion adapted to be attached to at least a portion of said nipple element; and a grasping member being integrally and detachably related to at least a portion of said backing portion. In a related embodiment, the grasping member is selected from the group consisting of a ring, a knob, a tab and a string-like tether.

### BRIEF DESCRIPTION OF THE DRAWINGS

FIG. 1 shows a perspective view of a flavored infant device.

FIG. 2 shows a side elevation view of a flavored infant device.

FIG. 3 shows a perspective view of a flavored infant device.

FIG. 4 shows a perspective view of a flavored infant device.

FIG. 5A-5D shows various views of another embodiment of the flavored infant device.

FIG. 6A-6D shows various views of another embodiment of the flavored infant device.

### DETAILED DESCRIPTION

While the making and using of various embodiments of the invention are discussed in detail below, it should be appreciated that the invention provides many applicable inventive concepts that can be embodied in a wide variety of specific contexts. The specific embodiments discussed herein are merely illustrative of specific ways to make and use the invention and do not delimit the scope of the invention.

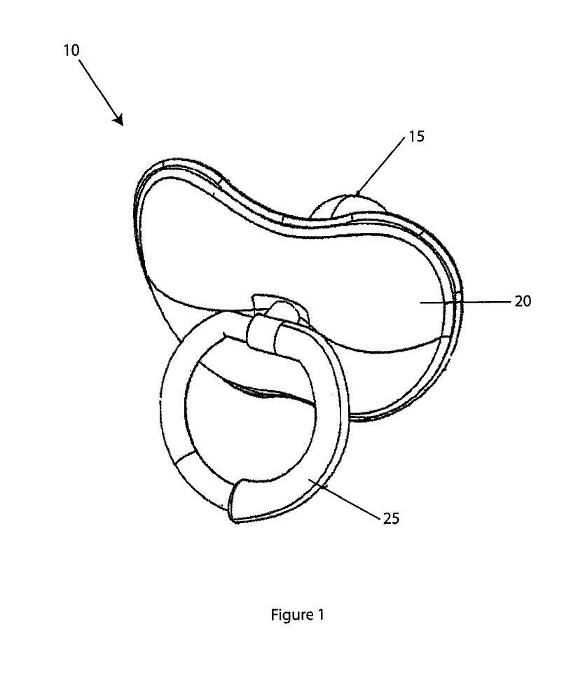

Referring now to the Figures, FIG. 1 shows a perspective view of a flavored infant device (herein also referred to as a pacifier or bottle nipple). In this example embodiment, a flavored infant device 10 is shown having a nipple 15, a backing portion 20 and a ring portion 25. Although the use of the disclosed invention is discussed within the scope of use for infants, other animals that may utilize a bottle or pacifier are within the scope of user contemplated.

Nipple 15 is a generally soft material to prevent contusions or discomfort while in an infants mouth. Materials such as polyurethane, polyethylene, polypropylene, polyvinylchloride (PVC), silicone, latex and combinations thereof are contemplated. Nipple 15 is infused with a flavor to provide an appealing taste and to enhance the overall experience of an infant using flavored infant device 10.

In at least one example of embodiment, flavor infant device 10 includes a detachable nipple 15 that allows for the removal of nipple from the backing portion 20 once a predetermined number of uses have occurred, which would indicate a lower concentration of flavoring provided to the user. Nipple 15 may also be replaced to change the flavor infused within the nipple material.

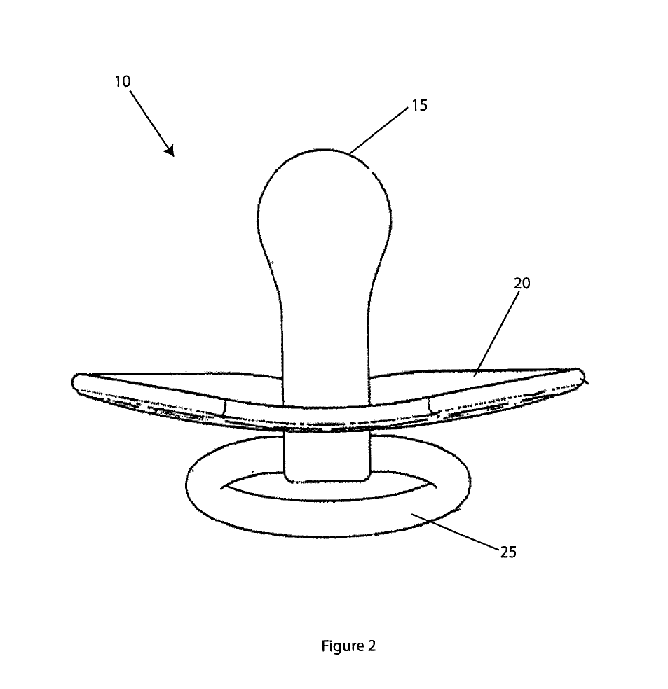

As best shown in FIGS. 1-6, Nipple 15 is attached to backing portion 20 which allows for flavored infant device to rest against a user's face and prevent the inadvertent ingestion of nipple 15 when flavored infant device 10 is in use.

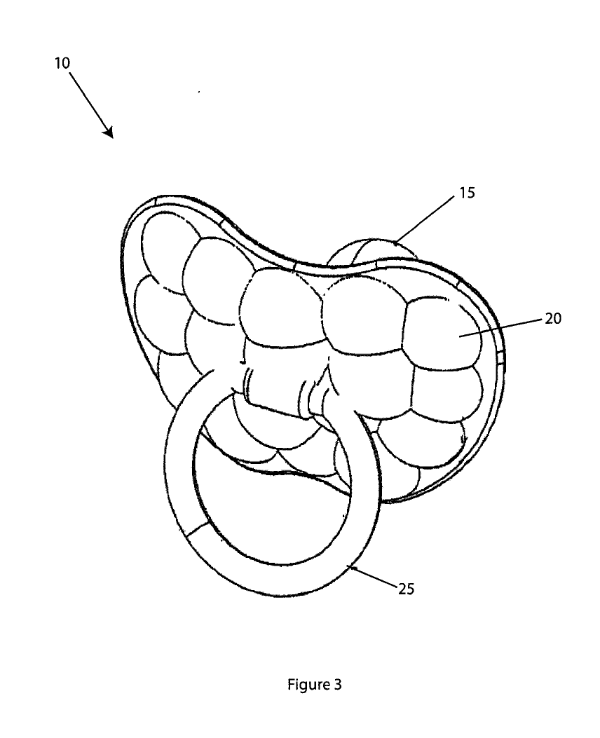

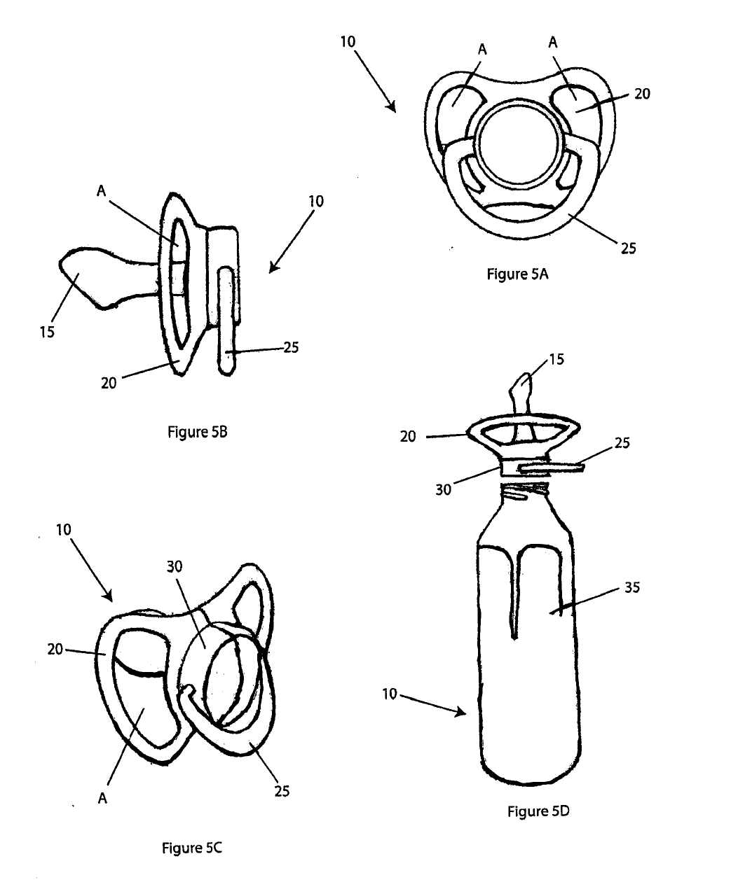

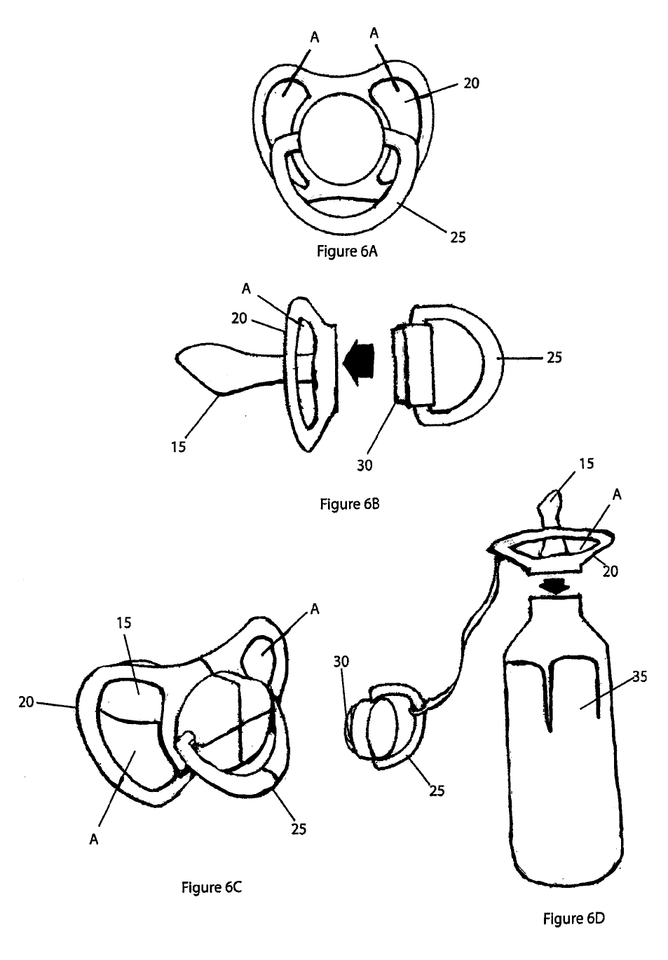

Backing portion 20 is typically made of a plastic material that is typically dishwasher safe and/or provides a surface that is easy to clean. Backing portion 20 and nipple 15 may be permanently coupled as shown in FIGS. 1-4. As shown in FIGS. 1 and 3, backing portion 20 is a uniform singular portion, without additional holes or apertures. Conversely, FIGS. 5 and 6 show backing portion containing apertures (A). Backing portion 20 and nipple 15 may be removeably attached from one another. Similarly, nipple 15 and backing portion 20 may be coupled together and removeably attached to ring 25, as best depicted in 6B.

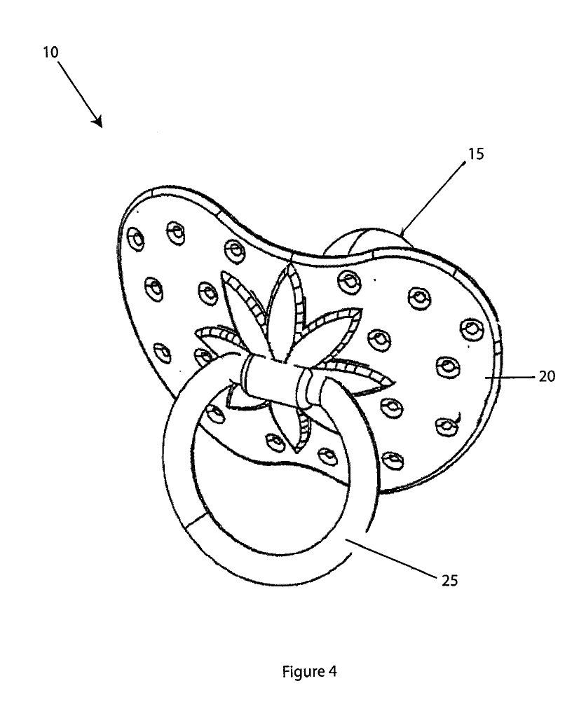

FIGS. 1, 2 and 3 show backing portion 20 having a variety of designs, such as smooth surface design (FIG. 1), grape design (FIG. 3) and berry design (FIG. 4). The disclosed embodiments shown depict a nonexclusive list of designs and configurations of backing portion 20. Although the designs do not provide a functional improvement towards the delivery of flavor to the infant, the design may provide a designation of the type of flavor infused within the nipple material. Additionally, backing portion 20 designs may provide an aesthetically appealing look to the consumer.

Backing portion 20 may also be integrally related to ring 25. Ring 25 may be used to allow a person delivering flavored infant device 10 to a child the ability to conveniently handle the device. Moreover, ring 25 may also provide a means of attaching flavored infant device 10 to a tether to prevent the inadvertent loss or dropping of the flavored infant device 10 when in use. As shown in FIG. 6B, ring 25 may be removed from backing portion 20.

Threaded portion 30 extends from backing portion 20 and provides a means of connecting ring 25 to backing portion 20. As best shown in FIGS. 5 and 6, threaded portion 30 also provides a means of connecting flavored infant device 10 to a bottle 35 (FIGS. 5D and 6D). It should be appreciated that threaded portion 30 may terminate on one side of backing portion 20 or may alternatively pass through backing portion to allow access to threaded portion 30 from each side of backing portion 20.

In the two-sided configuration, threaded portion 30 may provide a means of attaching flavored infant device 10 to a bottle 35 in a use position (FIGS. 5D and 6D). Alternatively, infant flavored device 10 may also be placed in an “non-use” configuration where nipple 15 portion is placed in the internal cavity of a bottle 35. This dual configuration allows for the nipple and backing portion to deliver flavor enhancement when in use and provide a means of protecting nipple 15 from inadvertently coming into contact with the external environment when not being used.

In one example embodiment, nipple 15 comprises at least two layers. In this embodiment, the outer surface of nipple 15 is infused with a flavoring that enhances and appeals to an infant. In another embodiment, nipple 15 is made in one piece to avoid it becoming a choking hazard. In at least this example embodiment, the flavor is substantially infused throughout the entire nipple material. A non-exhaustive list of flavors include those utilized with baby food such as butternut squash, carrots, green beans, peas, sweet potatoes, wax beans, apple, bananas, pears, peaches, blueberry, mango, apricot, kiwi, plum, corn, strawberry and raspberry.

When in use flavored infant device 10 is placed in an infants mouth. The infused flavor will provide a sensation to the taste buds of the infant. When use with a bottle, a person providing the flavored infant device 10 may use flavor combinations that are similar to the composition in the bottle. Alternatively, the flavor infused in the nipple may be used to provide a combination of flavors. Stated another way, the flavor infused in nipple 15 may be different than the flavor of the composition bottle 35. The flavored infant device 10 may also be used to see an infants likes or dislikes prior to integrating baby foods into their diet. Similarly, the use of a flavor infused nipple may allow for a parent of caretaker to integrate different flavors as a precursor to feeding an infant baby food.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims.

It is indeed intended that the scope of the invention should be determined by proper interpretation and construction of the appended claims and their legal equivalents, as understood by those of skill in the art relying upon the disclosure in this specification and the attached drawings.

1. An infant device for administering a flavor comprising:
a nipple element configured to have at least one layer infused with a flavor;
a backing portion adapted to be attached to at least a portion of said nipple element; and
a grasping member being integrally related to at least a portion of said backing portion.

2. The infant device according to claim 1, wherein said nipple element comprises at least two layers and wherein an outer layer of said nipple is infused with flavor and an inner layer is substantially free of infused flavor.

3. The infant device according to claim 1, wherein said backing portion further comprises a threaded portion, wherein said threaded portion provides securement of said grasping member to said backing portion.

4. The infant device according to claim 1, wherein said backing portion further comprises a threaded portion, wherein said threaded portion being compatible with a bottle.

5. The infant device according to claim 4, wherein said threaded portion provides for the infant device to be removeably attached to the bottle and configured for attachment in a non-use position.

6. The infant device according to claim 4, wherein said threaded portion provides for the infant device to be removeably attached to the bottle and configured for attachment in a use position.

7. The infant device according to claim 3, wherein the grasping member detaches from the backing portion with a corresponding male configuration of the threaded portion.

8. The infant device according to claim 1, wherein said flavor is selected from a group consisting of butternut squash, carrots, green beans, peas, sweet potatoes, wax beans, apple, bananas, pears, peaches, blueberry, mango, apricot, kiwi, plum, corn, strawberry and raspberry.

9. The infant device according to claim 1, wherein said nipple comprises a material selected from a group consisting of polyurethane, polyethylene, polypropylene, polyvinylchloride (PVC), silicone, latex and combinations thereof.

10. A method of administering a flavor to an infant comprising;
providing a favored infant device to an infant in need thereof, wherein said flavored infant device comprises a grasping member, a nipple element and a backing portion.

11. The method of claim 10, further comprising the step of providing a threaded portion to said backing portion thereby facilitating exposure of an inner part of the nipple element when the threaded portion is used.

12. The method of claim 10, further comprising the step of placing a new flavor infused nipple element on the flavored infant device.

13. The method of claim 10, further comprising the step of threading the flavored infant device onto a bottle in a use position, wherein said use position disposes the nipple element in an orientation allowing an infant to drink the contents of said bottle.

14. The method of claim 13, wherein said bottle contains a liquid food product similar to the flavor infused within said nipple element.

15. The method of claim 13, wherein said bottle contains a liquid food product different from the flavor infused within said nipple element.

16. The method of claim 13, further comprising the step of changing the flavored infant device from a use position to a non-use position, wherein said non-use position having said nipple element orientation towards the internal cavity of said bottle.

17. An infant device for administering a flavor comprising:
a nipple element configured to have at least one layer infused with a flavor;
a backing portion adapted to be attached to at least a portion of said nipple element; and
a grasping member being integrally and detachably related to at least a portion of said backing portion.

18. The infant device according to claim 17, wherein said nipple element comprises at least two layers and wherein an outer layer of said nipple is infused with flavor and an inner layer is substantially free of infused flavor.

19. The infant device according to claim 17, wherein said backing portion further comprises a threaded portion, wherein said threaded portion provides securement of said grasping member to said backing portion.

20. The infant device of claim 17, wherein said grasping member is selected from the group consisting of a ring, a knob, a tab and a string-like tether.
